(19) United States
(12) Patent Application Publication
(10) Pub. No.: US 2004/0190572 A1
(43) Pub. Date: Sep. 30, 2004

(54) Drive circuit for laser diode

(76) Inventor: Yasuyuki Kawanishi, Osaka (JP)

Correspondence Address: FISH & RICHARDSON P.C., 45 ROCKEFELLER PLAZA, SUITE 2800, NEW YORK, NY, 10111, US

(21) Appl. No.: 10/752,158

(22) Filed: Jan. 6, 2004

(30) Foreign Application Priority Data
Mar. 26, 2003 (JP) 2003-085664

(51) Int. Cl. H01S 3/00

(52) U.S. Cl. 372/38.02

(57) ABSTRACT

A laser-diode drive circuit is provided with a filter circuit for noise elimination. A measure is taken to eliminate a fear that a leading edge of a signal waveform is so impaired due to a time constant of the filter circuit that a receiving side of optical communications may not be able to accurately detect a level 0 or 1 of the signal at rise time. For this purpose, a laser-diode drive circuit of the invention includes a control-signal generating circuit for generating a control signal over a predetermined time period immediately after the rise of an input signal waveform or an output current signal waveform, and a time-constant reduction circuit active to reduce the time constant of the filter circuit during the receipt of the control signal.

This application is based on application No.2003-085664 filed in Japan, the content of which is incorporated hereinto by reference.

### BACKGROUND OF THE INVENTION

1. Field of the Invention

The present invention relates to a laser-diode drive circuit for use in an optical transmission apparatus employing a semiconductor laser (generally referred to as a laser diode).

2. Description of the Related Art

Recently, the speed of optical communications has been even more increased. This is accompanied by the speed-up of a signal (referred to as a “burst signal”) which consists of a digital signal having the levels of 0 and 1 and is supplied to a laser-diode drive circuit so as to be used for communication purposes. Specifically, the digital signal having the levels of 0 and 1 included in the burst signal has such a bit period as reduced to the order of 1 to 10 nanoseconds.

The laser-diode drive circuit converts the electrical amplitude of the burst signal to varied magnitudes of drive current for a laser diode.

In general, the laser-diode drive circuit is provided with filter circuits for elimination of noises entering an input voltage signal (the aforesaid burst signal) and an output current signal (the aforesaid drive current).

Unfortunately, there is a fear that leading edges of signal waveforms are impaired due to time constants of these filter circuits so that a receiving side of the optical communications may not be able to accurately detect the level 0 or 1 of the signal at rise time.

It may be contemplated to omit the filter circuits. However, the omission of the filter circuits results in increased noises which, in turn, lower the quality of communications.

### BRIEF SUMMARY OF THE INVENTION

In view of the foregoing, it is an object of the invention to provide a laser-diode drive circuit ensuring transmission of high-quality optical signals while exploiting the function of the filter circuits.

According to the invention, a laser-diode drive circuit comprises: a filter circuit provided for the purpose of eliminating noises entering an input signal inputted to the laser-diode drive circuit and an output current signal outputted therefrom for driving a laser diode; a control-signal generating circuit for generating a control signal over a predetermined time period immediately after the rise of an input signal waveform or an output current signal waveform; and a time-constant reduction circuit responsive to the control signal to reduce a time constant of the filter circuit.

According to this arrangement, the time constant of the filter circuit is reduced only for the predetermined time period immediately after the rise of the input signal waveform or the output current signal waveform and hence, the leading edge of the signal waveform can be correspondingly sharpened. It is noted that the “reduction of the time constant” means to include a reduction of the time constant to 0.

The time-constant reduction circuit may be a circuit for bypassing a current to flow through the filter circuit serially inserted in a current path or otherwise, be a circuit for shutting off the filter circuit from the current path, the filter circuit inserted in parallel in the current path.

The control-signal generating circuit may comprise hardware such as a Schmidt trigger circuit or may be composed using software.

In another aspect of the invention, the laser-diode drive circuit may include a current compensation circuit for compensating for a current through the current path instead of the time-constant reduction circuit responsive to the control signal to reduce the time constant of the filter circuit.

According to this arrangement, the current compensation circuit is able to supply a required amount of current for signal wave formation to the current path immediately after the rise of the input signal waveform or the output current signal waveform and without delay from the time constant of the filter circuit.

The current compensation circuit may be, for example, a current source for supplying a required amount of current to the current path.

The control-signal generating circuit may comprise hardware such as a Schmidt trigger circuit or may be composed using a software.

As described above, the invention provides for the formation of the signal waveform immediately after the rise of a burst signal waveform by virtue of the reduction of the time constant of the filter circuit or the addition of the current and hence, can prevent the leading edge of the signal waveform from being impaired. Consequently, a usual quality degradation of the output signal waveform can be obviated. Although the noises may potentially enter the signal immediately after the rise of the burst signal waveform, a constant occurrence of the noises can be prevented because the filter circuit is connected immediately after the stabilization of the signal.

### BRIEF DESCRIPTION OF THE DRAWINGS

FIG. 1 is a circuit diagram showing a laser-diode drive circuit according to the invention;

FIG. 2 is a graph representing a time-varying drive current I for a laser diode;

FIG. 3A is a graph representing a waveform of a burst signal, whereas FIG. 3B is a graph representing a waveform of a burst start signal;

FIG. 4A is a graph representing an idealistic waveform of an LD drive signal, whereas FIG. 4B is a graph representing a waveform of an LD drive signal delayed rising due to a filter circuit;

FIG. 5A is a circuit diagram showing a series filter circuit composed of a resistor R and a coil L, whereas FIG. 5B is a circuit diagram showing a control-signal generating circuit which is responsive to the burst start signal to short a coil L by means of a switching device;

FIG. 6A is a circuit diagram showing a parallel filter circuit composed of a resistor R and a coil L, whereas FIG. 6B is. a circuit diagram showing a control-signal generating circuit which is responsive to the burst start signal to shut off a shunt from a current path by means of a switching device;

FIG. 7 is a circuit diagram showing a control-signal generating circuit composed of a current source connected in parallel with a series filter circuit essentially including a resistor R, a coil L and a capacitor C; and a switching device for ON/OFF switching of the current source;

FIG. 8 is a circuit diagram showing a control-signal generating circuit composed of a Schmidt trigger circuit; and

FIG. 9A is a diagram showing a waveform of a burst start signal whereas FIG. 9B is a diagram showing a waveform of a corresponding output signal outputted from the Schmidt trigger circuit.

### DETAILED DESCRIPTION OF THE INVENTION

Preferred embodiments of the invention will hereinbelow be described in details with reference to the accompanying drawings.

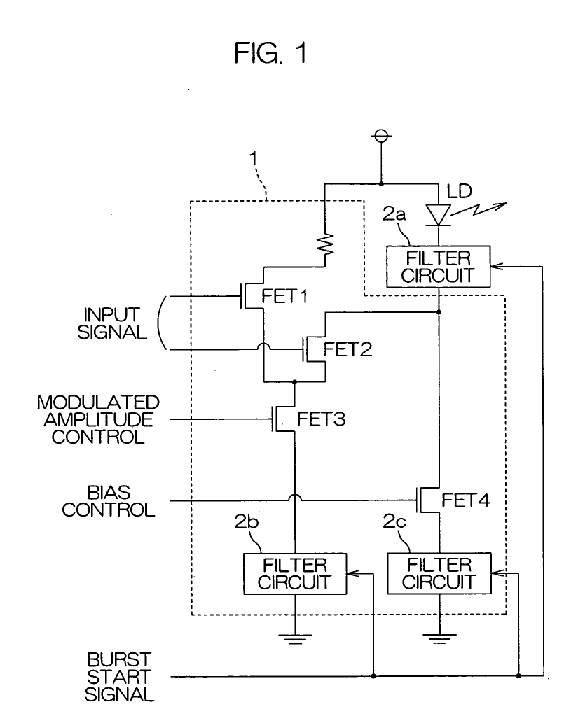

FIG. 1 is a circuit diagram showing a laser-diode drive circuit 1 according to the invention.

The LD drive circuit 1 includes: a differential amplifier circuit including two FETs 1, 2; an FET3 for controlling modulated amplitude; an FET4 for setting a bias for an LD; the LD under a load of the differential amplifier circuit; and filter circuits 2a, 2b, 2c (hereinafter, a reference numeral “2” will collectively represents the filter circuits) individually connected in series with the LD, modulated-amplitude controlling FET3 and bias setting FET4. A path in which these filter circuits 2 are inserted is referred to as a “current path”.

A burst signal for fast ON/OFF switching of a laser diode is inputted to gates of the two FETs 1, 2 constituting the differential amplifier circuit via a signal circuit (not shown). A modulated amplitude signal is inputted to a gate of the modulated-amplitude controlling FET3 whereas a bias setting signal is inputted to a gate of the bias setting FET4. A burst start signal is inputted to the three filter circuits 2 via a signal circuit (not shown), respectively.

The filter circuits 2 are provided for the purpose of eliminating noises superimposed on a drive current signal, the modulated-amplitude signal and the bias setting signal, respectively.

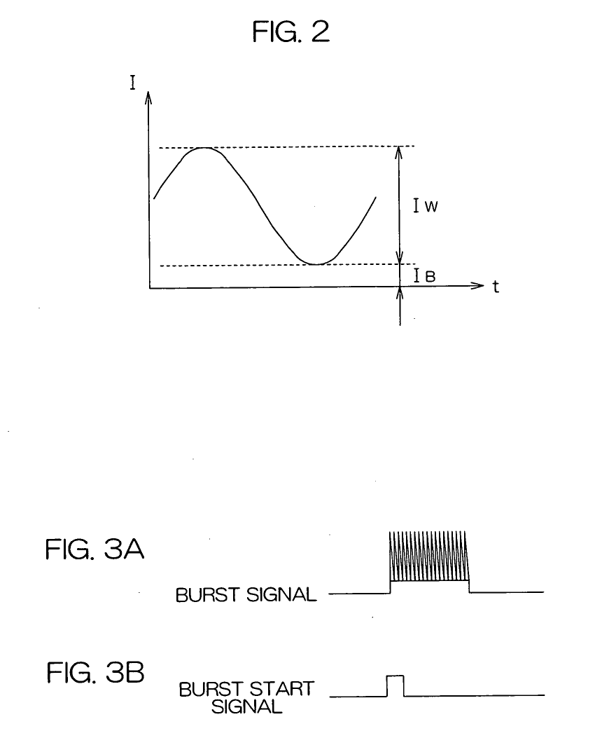

FIG. 2 is a graph representing a relation between a drive current I for the laser diode and time t. In the figure, ‘Iw’ represents the width of an amplitude of the LD drive current I whereas ‘I_{B}’ represents the value of the bias current. The amplitude width Iw is decided according to the magnitude of the aforesaid modulated amplitude signal whereas the value of the bias current I_{B} is decided according to the magnitude of the bias setting signal.

As shown in FIG. 3A, the burst signal alternates between 1 and 0 in quite a short period (e.g., 1 to 10 nanoseconds). The LD drive circuit 1 generates the drive current I based on the burst signal, the drive current serving to drive the laser diode. The intensity of an optical output from the laser diode is modulated with the drive current signal. The resultant light enters a transmission optical fiber (not shown) to propagate therethrough.

The burst start signal occurs at the point of time that the burst signal rises (FIG. 3B). The burst start signal is generated in the signal circuit (not shown) when the burst signal is generated. The burst start signal is supplied to the filter circuits 2.

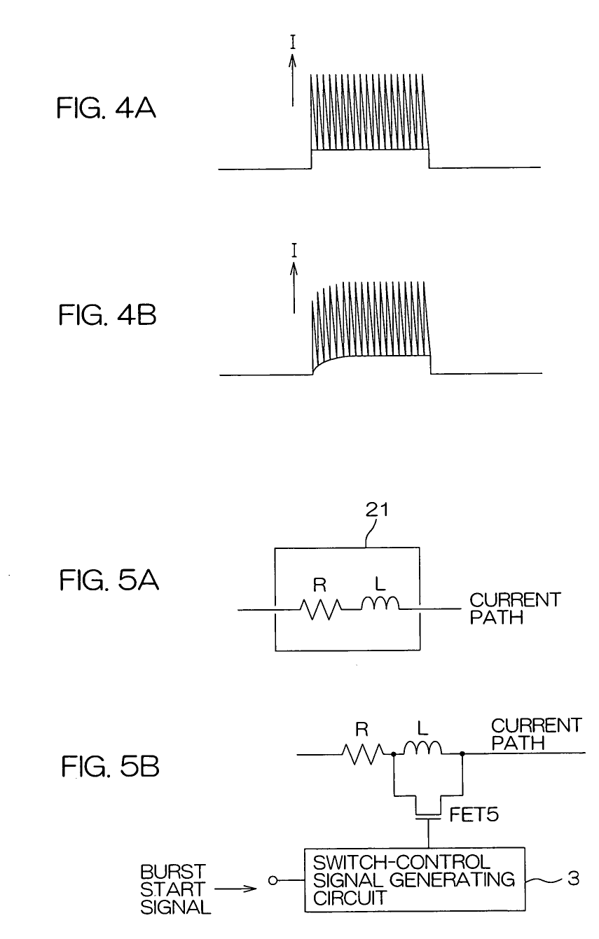

The LD drive signal outputted from the differential amplification circuit may idealistically have a square waveform, as shown in FIG. 4A. With the aforesaid filter circuits 2 inserted in the current path, however, a leading edge of the signal waveform is impaired due to a time constant of the filters, as shown in FIG. 4B.

According to the invention, therefore, the waveform is shaped by taking measures such as to bypass a portion of the filter circuit that decides the time constant, to remove the filter or to actively add a current thereby to reduce a practical time constant immediately after the rise of the burst waveform.

Next, description is made on specific examples of the filter circuit 2 and a method for practically reducing the time constant thereof.

FIG. 5A illustrates a series filter circuit 21 composed of a resistor R and a coil L, whereas FIG. 5B illustrates a circuit which is operative based on the burst start signal to short the coil L by means of a switching device FET5. The switching device FET5 constitutes a “time-constant reduction circuit”.

The burst start signal is inputted to a switch-control signal generating circuit 3, which generates a switch control signal to be supplied to a gate of the switching device FETS. The switching device FETS is allowed to conduct by the switch control signal so as to short the coil L. Thus, the time constant is substantially reduced to 0 while the coil is shorted.

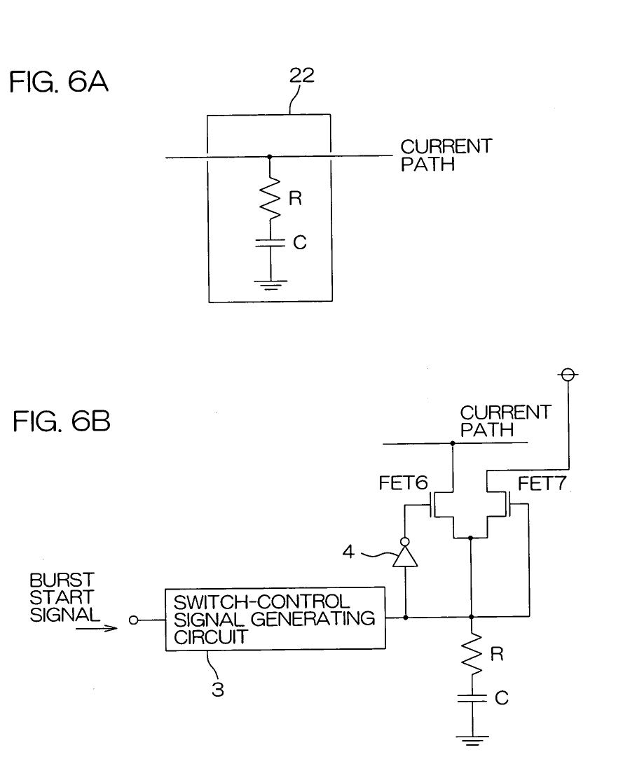

FIG. 6A illustrates a parallel filter circuit 22 composed of a resistor R and a capacitor C, whereas FIG. 6B illustrates a circuit which is operative based on the burst start signal to shut off a shunt from the current path by means of a switching device FET6. The switching device FET6 constitutes the “time-constant reduction circuit”.

The burst start signal is inputted to the switch-control signal generating circuit 3 which, in turn, supplies the signal to a gate of the switching device FET6 via an inverter circuit 4. This shuts off the switching device FET6. Therefore, the shunt from the current path, which is composed of the resistor R and the coil L, becomes inactive and in the meantime, the time constant is substantially reduced to about 0.

Although the shunt is connected at disappearance of the burst start signal, it is undesirable to use the current flowing through the current path at this time for charging the capacitor C. Hence, a switching device FET7 is allowed to conduct during the shut-off of the switching device FET6 thereby charging the capacitor C with a current from a current source.

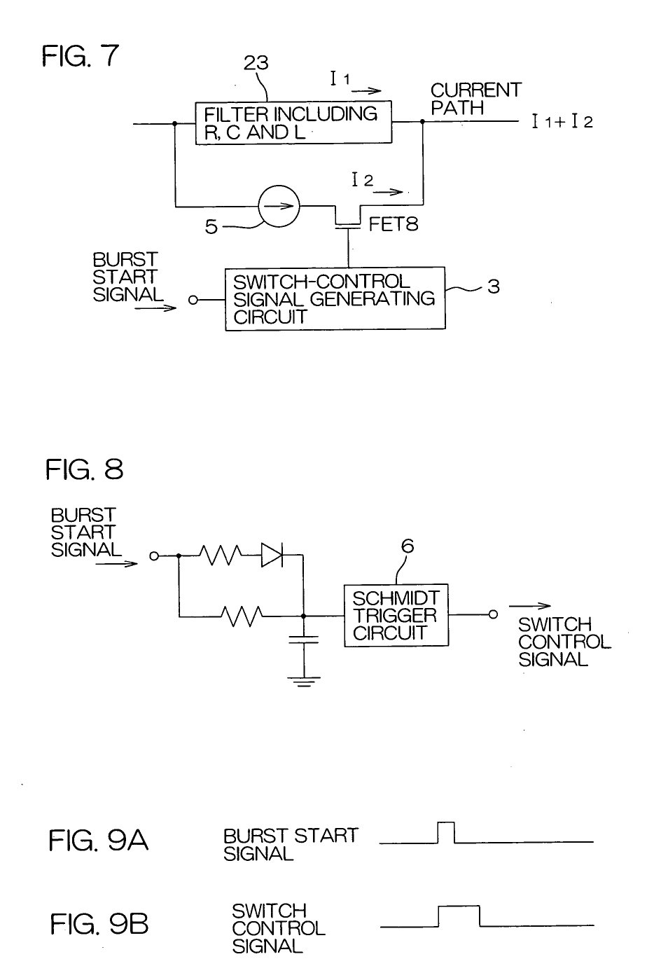

FIG. 7 illustrates a circuit including a series filter circuit 23 composed of a resistor R, a coil L, a capacitor C and the like; a current source 5 connected in parallel therewith; a switching device FET8 for ON/OFF switching of the current source 5; and the switch-control signal generating circuit 3. The current source 5 and switching device FET8 constitute a “current compensation circuit”.

The burst start signal is inputted to the switch-control signal generating circuit 3 which, in turn, generates the switch control signal to be supplied to a gate of the switching device FET8. The appearance of the switch control signal allows the switching device FET8 to conduct so that the current from the current source 5 is added to a current through the series filter circuit 23 whereby the level of the overall current is raised. Thus, a faster rise of the drive current I at the leading edge of the burst waveform is attained.

Now, a specific example of the configuration of the switch-control signal generating circuit 3 will be described. The switch-control signal generating circuit 3 may be composed of a hardware or a software.

FIG. 8 is a circuit diagram illustrating one example where the circuit is composed of a hardware such as a Schmidt trigger circuit 6. The Schmidt trigger circuit 6 has different time constants at ON time and OFF time and hence, is capable of outputting a signal which rises substantially in synchronism with the rise of the burst start signal and which falls with a certain delay from the fall time of the burst start signal.

FIG. 9A depicts a waveform of the burst start signal whereas FIG. 9B depicts a corresponding output signal from the Schmidt trigger circuit 6.

In a case where a software is used to compose the switch-control signal generating circuit, a program for changing the pulse width may be stored in a programmable logic IC or a CPU with an output interface which is operative based on the burst start signal to provide an output signal increased in the pulse width. An advantage of using the software for circuit formation is in that the characteristics of the circuit may be flexibly changed according to environmental conditions such as temperature.

While the embodiments of the invention have been described, it is to be noted that the practice of the invention is not limited to the foregoing embodiments. According to FIG. 1, for instance, the filter circuits 2a, 2b, 2c are serially inserted in the respective current paths to the LD, the modulated-amplitude controlling FET3, and the bias setting FET4. However, the working effect of the invention may also be obtained simply by inserting filter circuits in any two of the current paths to the LD, modulated-amplitude controlling FET3 and bias setting FET4 in stead of using all the three filter circuits 2a, 2b, 2c. Otherwise, the working effect of the invention can also be obtained by inserting the filter circuit only in any one of the current paths to the LD, modulated-amplitude controlling FET3 and bias setting FET4. While the switching devices FETs 5-8 used in the foregoing embodiments function as switches, the devices may be adapted to operate as a variable resistor by properly setting an operating point of a semiconductor device, the variable resistor varied in resistance in an analog fashion. Furthermore, other various changes and modifications may be made within the scope of the invention.

1. A laser-diode drive circuit comprising:
a filter circuit provided for the purpose of eliminating noises entering an input signal inputted to the laser-diode drive circuit and an output current signal outputted therefrom for driving a laser diode;
a control-signal generating circuit for generating a control signal over a predetermined time period immediately after the rise of an input signal waveform or an output current signal waveform; and
a time-constant reduction circuit active to reduce a time constant of said filter circuit during the receipt of said control signal.

2. A laser-diode drive circuit according to claim 1, wherein said time-constant reduction circuit functions as a current bypass circuit for the filter circuit serially inserted in a current path.

3. A laser-diode drive circuit according to claim 1, wherein said time-constant reduction circuit functions as a circuit for shutting off the filter circuit from a current path, the filter circuit inserted in parallel in the current path.

4. A laser-diode drive circuit according to claim 1, wherein said control-signal generating circuit comprises a Schmidt trigger circuit.

5. A laser-diode drive circuit according to claim 1, wherein said control-signal generating circuit uses software for generating the control signal.

6. A laser-diode drive circuit comprising;
a filter circuit provided for the purpose of eliminating noises entering an input signal inputted to the laser-diode drive circuit and an output current signal outputted therefrom for driving a laser diode;
a control-signal generating circuit for generating a control signal over a predetermined time period immediately after the rise of an input signal waveform or an output current signal waveform; and
a current compensation circuit active to compensate for a current through a current path during the receipt of said control signal.

7. A laser-diode drive circuit according to claim 6, wherein said current compensation circuit includes a current source for supplying a required amount of current to the current path.

8. A laser-diode drive circuit according to claim 6, wherein said control-signal generating circuit comprises a Schmidt trigger circuit.

9. A laser-diode drive circuit according to claim 6, wherein said control-signal generating circuit uses software for generating the control signal.
